(19) United States
(12) Patent Application Publication
(10) Pub. No.: US 2022/0135392 A1
(43) Pub. Date: May 5, 2022

(54) VACUUM BREAK TWIST CAP DISPENSER ASSEMBLIES

(71) Applicant: LB Europe Limited, Manchester (GB)

(72) Inventors: Ronald E. Kieras, McHenry, IL (US); Matthew Ruschmeier, Glencoe, MN (US)

(21) Appl. No.: 17/516,090

(22) Filed: Nov. 1, 2021

Related U.S. Application Data
(60) Provisional application No. 63/109,170, filed on Nov. 3, 2020.

(51) Int. Cl. B67D 3/04

(52) U.S. Cl. CPC B67D 3/047

(57) ABSTRACT

An example dispenser assembly system having an inlet connection, an outlet connection, a valve body, a plunger, and a twist cap, the dispenser assembly system configured to provide a connection between a liquid container and a dispensing system inlet connection and further provide the ability of an operator to control the flow between the liquid supply source and the dispensing system inlet through the rotation of the twist cap.

### RELATED APPLICATIONS

This application is related to, and claims priority to, U.S. Provisional Application No. 63/109,170, filed Nov. 3, 2020, titled “Vacuum Break Twist Cap Dispenser Assemblies,” the complete subject matter and contents of which are incorporated herein by reference in its entirety.

### BACKGROUND

This disclosure relates generally to liquid storage equipment and, more particularly, to dispenser assembly systems for liquid containers. In this area of liquid storage equipment, there is a need to be able to cost effectively connect a liquid storage container, such as a bag in box type container, to a dispensing system with an inlet hose connection.

### SUMMARY

Certain embodiments of the present technology relate to a dispenser assembly for dispensing fluid. The dispenser assembly includes an inlet connection, an outlet connection, and a valve assembly that connects the inlet connection with the outlet connection. The inlet connection includes a first cylindrical wall, a flange that extends from an outer surface of the first cylindrical wall, and a second cylindrical wall between the flange and the valve assembly. The inlet connection is configured to connect to a source of a liquid. The outlet connection is configured to connect to a discharge hose. The valve assembly includes a valve body, a plunger and a twist cap. The valve assembly controls the amount of flow from the inlet connection and the outlet connection based on the rotation of the twist cap. The inlet connection, the valve body, and the outlet connection are molded as a single unit.

The outlet connection may include a barb.

The flange may include an outer radial edge and a plurality of flange protrusions that extend from the outer radial edge.

The first cylindrical wall may have an outer diameter, and the second cylindrical wall may have an outer diameter that is smaller than the first cylindrical wall outer diameter.

The first cylindrical wall may include a pointed end. The first cylindrical wall may include a barb. The first cylindrical wall barb may form a continuous surface around the first cylindrical wall. The first cylindrical wall barb may include a plurality of separate points extending from the first cylindrical wall. The first cylindrical wall may include a plurality of wall openings between the separate points.

Other embodiments of the present technology may also include an inlet connection, an outlet connection, and a valve assembly that connects the inlet connection with the outlet connection. The inlet connection includes a cylindrical wall and a threaded surface that extends from the cylindrical wall. The inlet connection is configured to connect to a source of a liquid. The outlet connection is configured to connect to a discharge hose. The valve assembly includes a valve body, a plunger and a twist cap. The valve assembly controls the amount of flow from the inlet connection and the outlet connection based on the rotation of the twist cap. The inlet connection, the valve body, and the outlet connection are molded as a single unit.

The outlet connection may include a barb.

The threaded surface may extend from the inner surface of the cylindrical wall. The threaded surface may extend from the outer surface of the cylindrical wall. The dispenser assembly may also include a gasket and retention nut. The gasket and retention nut may fit over the outer threaded surface of the cylindrical wall.

Other embodiments of the present technology may also include an inlet connection, an outlet connection, and a valve assembly that connects the inlet connection with the outlet connection. The inlet connection includes a cylindrical wall and a barb that extends from the cylindrical wall. The inlet connection is configured to connect to a source of a liquid. The outlet connection is configured to connect to a discharge hose. The valve assembly includes a valve body, a plunger and a twist cap. The valve assembly controls the amount of flow from the inlet connection and the outlet connection based on the rotation of the twist cap. The inlet connection, the valve body, and the outlet connection are molded as a single unit.

The outlet connection may include a barb. The outlet connection and inlet connection may have the same outer diameter.

The inlet connection may include a tapered end.

### BRIEF DESCRIPTION OF THE DRAWINGS

FIG. 1 is a cross section view of an example dispenser assembly system having an inlet connection, an outlet connection, a valve body, a plunger, and a twist cap, in accordance with aspects of this disclosure.

FIG. 2 is an exploded view of the example dispenser assembly system of FIG. 1.

FIG. 3A is a front view of the example dispenser assembly system of FIG. 1.

FIG. 3B is a side view of the example dispenser assembly system of FIG. 1.

FIGS. 3C-3E are perspective views of the dispenser assembly system of FIG. 1 along with the corresponding connector of the liquid supply source in an uninstalled, partially installed, and fully installed condition.

FIG. 4A is a perspective view of a second embodiment of the claimed dispenser system having an inlet connection configured to mate with a bag in box system.

FIG. 4B is a different perspective view of the second embodiment of FIG. 4A.

FIG. 4C is a side view of the second embodiment of FIG. 4A fully installed into a bag in box system.

FIG. 5A is a perspective view of a third embodiment of the claimed dispenser system with an inlet connection having a barbed end.

FIG. 5B is a side view of the dispenser system of FIG. 5A.

FIG. 6A is a perspective view of a fourth embodiment of the claimed dispenser system with an inlet connection having a pointed end surface designed to pierce elastomeric sealing membranes. The inlet connection also has multiple barbed surfaces.

FIGS. 6B-D are different perspective views of the dispenser assembly system of FIG. 6A along with the corresponding connector of the liquid supply source in an uninstalled, partially installed, and fully installed condition.

FIG. 7A is a perspective view of a fifth embodiment of the claimed dispenser system having an inlet connection with a threaded outer surface.

FIGS. 7B and 7C are different perspective views of the dispenser assembly system of FIG. 7A along with the corresponding container and connector assembly of the liquid supply source in the uninstalled and fully installed conditions respectively.

FIG. 8A is a perspective view of a sixth embodiment of the claimed dispenser system having an inlet connection with a threaded inner surface.

FIGS. 8B and 8C are different perspective views of the dispenser assembly system of FIG. 8A along with the corresponding container and connector of the liquid supply source in the uninstalled and fully installed conditions respectively.

### DETAILED DESCRIPTION

In the field of liquid systems, there is a need for connecting a liquid supply container with a dispensing system while retaining the ability to control the flow between the container and the dispensing system.

Disclosed are example dispenser assembly systems designed to be connected to a liquid supply container and a dispensing system supply hose while being able to control the liquid flow between the supply and the dispensing system. The dispenser assembly integrates a twist top valve assembly to provide an operator with a method for reliably controlling the fluid flow.

In some example systems, the dispenser assembly is designed to be attached to and removed from a first liquid supply container and capable of being attached and removed from a second liquid supply container. In some example systems, the dispenser assembly is designed to be attached to and removed from an intermediary hose connected to a liquid supply container as well as the dispensing system supply hose. In other examples, the dispenser assembly may be designed to prevent reuse after a single attachment to either the liquid supply container and/or the hose of the dispensing system.

As used herein, the terms “first,” “second,” “third,” etc., are used to enumerate instances of similar or identical elements, and do not indicate or imply order unless an order is specifically identified.

As used herein, the term “inner surface” refers to the portion of a given component closest to the fluid flow path and the term “outer surface” refers to the portion of a given component away from the fluid flow path.

Turning now to the drawings, FIG. 1 is a cross section view of an example dispenser assembly system 100 having an inlet connection 110, an outlet connection 130, and a valve assembly 150. The inlet connection 110 provides the attachment point for a fluid source to the dispenser assembly system 100. The outlet connection 130 provides the discharge point of the dispenser assembly system 100. The valve assembly 150 provides the ability to control the fluid flow through the dispenser assembly system 100.

The inlet connection 110 includes a fluid inlet 112 and a fluid inlet channel 114 that allows a fluid to flow from the fluid source through the fluid inlet 112, through the fluid inlet channel 114, and to the valve assembly 150. The inlet wall 116 forms the fluid channel 114. The inlet wall 116 includes an inner surface 118 and an outer surface 120. As will be described subsequently in greater depth, various features may be added to either the inner surface 118 or the outer surface 120 of the inlet connection 110 in order to provide a sealing surface, an attachment surface, aid in installation or removal, or for other reasons relating to the connection to the liquid supply source or for other connections such as cleanliness covers or anti-tamper seals. In the embodiment of FIG. 1, the outer surface 120 has a tapered surface 122 towards the end of the inlet connection 110. This may minimize damage to a corresponding sealing surface such as a gasket or an O-ring of the liquid supply as the inlet connection 110 is inserted into the liquid supply source (not shown). After the taper, the outer surface 120 has a constant outer diameter, which may be used as a sealing surface with the liquid supply source. In other embodiments, the outer surface may have a second taper angle after an initial taper angle. The inlet connection 110 of this first embodiment also has a flange 124. The flange 124 may serve various purposes for the connection to the liquid supply source. The flange 124 may help set the distance the inlet connection 110 is inserted into the liquid supply source by abutting against a corresponding surface on the liquid supply source. In some embodiments, the flange 124 may provide a sealing surface against a gasket to prevent leakage between the liquid supply source and the inlet connection 110. As shown in the first embodiment, the flange 124 may also have flange protrusions 126 configured to engage corresponding features of the liquid supply source. The flange protrusions 126 may be used to lock the inlet connection into the liquid supply source. The inlet connection 110 may have one or multiple flange protrusions 126. In embodiments with multiple flange protrusions 126, the flange protrusions 126 may be radially spaced with constant distances between each protrusion. In some embodiments, the flange protrusions 126 may have different spacing or sizes between the protrusions to prevent an operator from installing the dispenser assembly system in the wrong orientation. In some embodiments, the flange protrusions 126 may have different spacing or sizes to correspond to a specific fluid or product to prevent an operator from connecting the incorrect fluid to a given system. Similarly, the outer diameter of the flange 124 could also vary to correspond to a specific product.

The outlet connection 130 dispenser assembly system 100 has many of the same features as the inlet connection 110, but allows fluid to flow from the valve assembly 150 to the hose connection of the dispensing system (both not shown). The outlet connection 130 includes a fluid channel 134 and a fluid outlet 132 that allows fluid to flow from the valve assembly 150 through the fluid outlet channel 134 and through the fluid outlet 132. The outlet wall 136 forms the fluid channel 134. The outlet wall 136 includes an inner surface 138 and an outer surface 140.

As with the inlet connection 110, various features may be added to the outlet channel's inner surface 138 or outer surface 140 for various purposes. In the first embodiment, a hose barb 142 is added to allow a flexible hose, tube, or pipe (not shown) to fit over the outlet connection 130. The hose barb 142 provides resistance from the connected hose from being removed. In some embodiments, a hose clamp (not shown) may be used in addition to, or in lieu of, the hose barb for maintaining the connection between the outlet connection 130 and the hose.

As already described, the valve assembly 150 is connected to the inlet connection 110 and the outlet connection 130. The valve assembly 150 includes a valve body 152, a plunger 154, and a twist cap 156. The twist cap 156 is configured to allow an operator to move the plunger 154 and thereby regulate the amount of fluid flowing from the inlet connection 110 to the outlet connection 130. The twist cap 156 may have a threaded inner surface 158. The threaded inner surface 158 of the twist cap 156 may engage an external threaded surface 160 of the plunger 154. By rotating the twist cap 156 in a first direction, a mating surface 162 of the plunger 154 is lifted away from a valve seat 164 creating a passage for fluid to flow between the mating surface 162 and the valve seat 164. The plunger 154 may also have a plunger window 166 on either side of the plunger 154 creating an internal passage 167 to allow fluid to flow through the body of the plunger 154. The internal passage 167 provides better control of the fluid flow through the valve assembly 150 by equalizing pressures around the valve seat 164, especially as the valve assembly 130 is first opened. In some instances, the hose connected to the outlet connection 130 may also be attached to a vacuum pump to help evacuate the contents of the container by forming a vacuum in the hose and the container when the valve assembly 150 is in an open position, further benefiting from the equalization of pressure through the internal passage 167.

The twist cap 156 may be secured onto the valve body 152 using a snap fit type connection. The valve body 152 of FIG. 1 includes a snap fit ledge 168. During assembly, the twist cap 156 slides over the snap fit ledge 168. Once fully installed, a snap fit lip (not shown) on the twist cap 156 engages the snap fit ledge 168 of the valve body 152 and prevents removal of the twist cap 156. The twist cap 156 forms an aseptic seal with the valve body 152 created along a sealing surface 170. The contact between the twist cap 156 and the valve body 152 at the sealing surface 170 prevents liquids and gases from entering or exiting the valve assembly 150 both during movement of the twist cap 156 as well as when the twist cap is stationary.

The twist cap 156 may have a plurality of grooves 172, a knurled surface, or other similar surface features on the outer edge to provide a better gripping surface for an operator thereby providing greater control while operating the twist cap 156.

Although described as separate components, the inlet connection 110, the outlet connection 130, and the valve body 152 may be formed as a single component as shown in FIG. 1, but the components may also be separately formed and then either mechanically attached such as with threads, with adhesives, using sonic welding, or with any other similar method known in the art. Any appropriate material may be used for this component based on the environment the dispenser assembly will be used in and the fluid being stored. High Density Poly Ethylene (HDPE) may be used for the valve body 152 and the plunger 154. Polypropylene may be used for the twist cap 156.

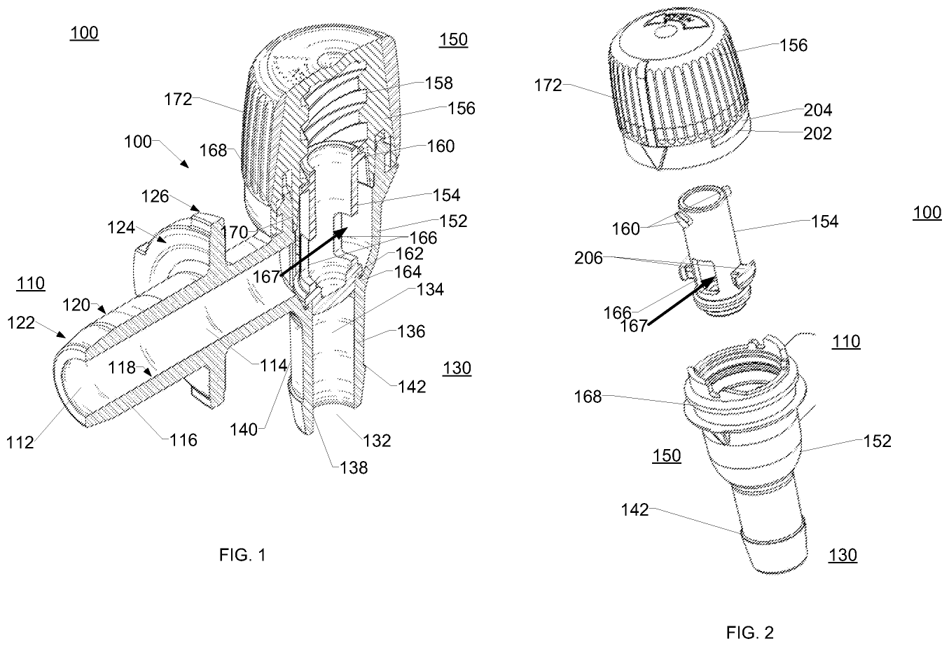

FIG. 2 is an exploded view of the dispenser assembly system 100 of FIG. 1. As previously described, the dispenser assembly system 100 includes the inlet connection 110, the outlet connection 130 and the valve assembly 150. The valve assembly 150 includes the valve body 152, the plunger 154, and the twist cap 156. From the perspective view of FIG. 2, the barb 142 of the outlet connection 130 can be viewed. The flange 124 of the inlet connection of FIG. 1 is not shown.

Regarding the valve assembly 150, the snap fit ledge 168 extends around the circumference of the upper area of the valve body 152. The twist cap 156 has a snap fit lip 202, as seen in FIG. 2, configured to engage the snap fit ledge 168 of the valve body 152. In this embodiment, the snap fit lip 202 extends from the bottom surface of a lip window 204. The twist cap 156 has the plurality of grooves 172. The plunger 154 has the plunger window 166 creating the internal passage 167 through the plunger 154. The plunger window 166 is located between a first and a second anti-rotation ledges 206. The anti-rotation ledges 206 are configured to engage anti-rotation channels (not shown) within the valve body 152. In the present embodiment, the plunger 154 also has two external threaded surfaces 160 to engage the internal threads of the twist cap 156 previously discussed. However, in other embodiments, the plunger 154 may have a single external thread, additional external threads, or a continuous external thread. The anti-rotation ledges 206 provide a counter-torque for the plunger 154 when an operator twists the twist cap 156 allowing the threaded surfaces 160 to raise and lower the plunger 154 within the valve body 152.

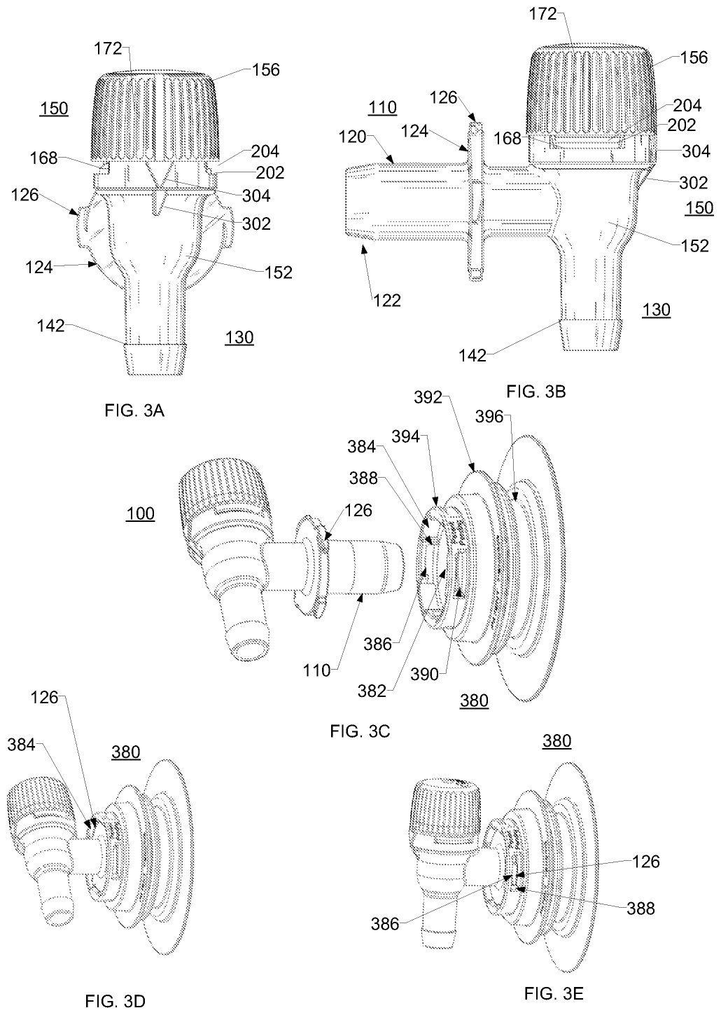

FIGS. 3A and 3B provide a front and a side view respectively of the first embodiment of the dispenser assembly system 100 of FIGS. 1 and 2. FIG. 3A shows the outlet connection 130 and the valve body 152 and twist cap 156 of the valve assembly 150. The flange 124 and flange protrusions 126 of the inlet connection are partially visible. A valve body position indicator 302 and twist cap position indicator 304 are shown on the valve assembly 150. The position indicators 302 and 304 provide a visual indication to an operator the valve is in the fully closed position when the two position indicators 302 and 304 are aligned. Additional markings on the valve body 152 may be added based on certain preferred flow rates. FIGS. 3A and 3B also provide another perspective of the snap fit ledge 168, the snap fit lip 202, and the lip window 204.

FIGS. 3C, 3D, and 3E are perspective views of the dispenser assembly system 100 along with the fluid supply connector 380 in the uninstalled (FIG. 3C), partially installed (FIG. 3D), and fully installed (FIG. 3E) conditions.

FIG. 3C shows the inlet connection 110 in line with the opening 382 of the fluid supply connector 380. The fluid supply connector 380 has a plurality of tab channels 384 that correspond to the size and shape of the flange protrusions 126. The embodiment of FIG. 3C has four equally sized and spaced tab channels 384. Adjacent to the tab channels 384, the fluid supply connector 380 has a series of tab ledges 386 and tab stops 388. The tab ledges 386 provide the axial support for the flange protrusions 126 in the installed state. The distance of the tab ledges 386 to the inner surface of the supply connector 380 correlates to the thickness of the flange protrusions 126. As shown in FIG. 3C, the flange protrusions 126 may have an initial taper to aid in the installation of the inlet connection 110 into the fluid supply connector 380. Similarly, a taper could be added to the tab ledges 386 in addition to or instead of the taper on the flange protrusions 126. The tab stops 388 provide a hard stop for the flange protrusions 126 as an operator rotates the inlet connection 110 within the fluid supply connector 380. In some embodiments, the fluid supply connector 380 may also have tab openings 390 corresponding to the inner surface of the tab ledges 386 and tab stops 388.

In some embodiments, the fluid supply connector 380 may further include an outer component 392, an inner component 394, and a spout 396. The outer component 392 and inner component 394 may retain a valve or secondary seal (not shown) such as a film, an elastomeric sheet, or a gasket. The film or elastomeric sheet may be scored to aid in the inlet connection rupturing the seal during installation. The spout 396 may be integrally formed with the container of the fluid source or may be attached with the container by other means such as sonic welding.

As shown in FIG. 3D, in order to install the inlet connection 110, the operator inserts the inlet connection 110 into the fluid supply opening 382. The operator aligns the flange protrusions 126 with the tab channels 384.

As shown in FIG. 3E, once the inlet connection 110 is fully inserted into the fluid supply opening 382, the operator can rotate the inlet connection 110. The operator continues to rotate the inlet connection 110 until the leading surfaces of the flange protrusions 126 abut against the tab stops 388, thus ensuring the flange protrusions 126 are fully supported by the tab ledges 386.

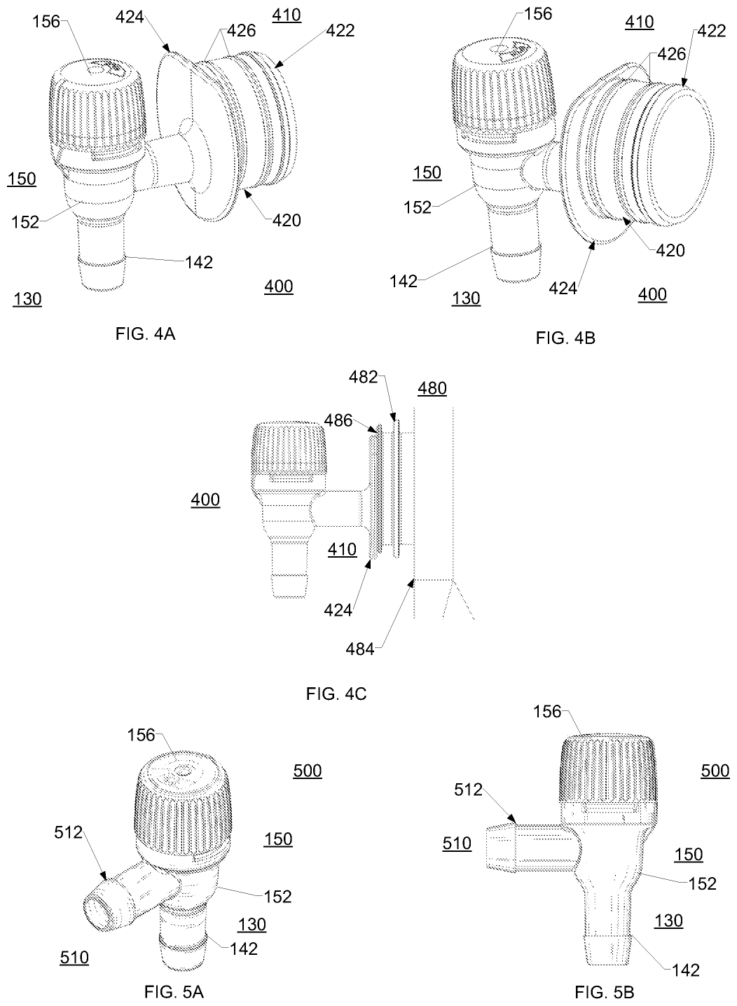

FIGS. 4A and 4B provide a first and second perspective view of a second embodiment of the claimed dispenser system. As with the first embodiment, the dispenser system assembly 400 of the second embodiment has an outlet connection 130, a valve assembly 150 with a valve body 152 and twist cap 156, as well as a different style inlet connection 410 as compared to the first embodiment. The inlet connection 410 is configured to mate with an alternate supply connection of a liquid source. In some embodiments, this liquid source may be a bag in box type liquid container.

Similar to the first embodiment, the inlet connection 410 has a flange 424. The flange 424 may provide the insertion depth for the inlet connection 410 into the supply connection of the fluid source. The outer surface 420 of the inlet connection may have other surface features such as an initial tapered surface 422. The second embodiment also has a plurality of ridges 426. These ridges 426 may help create a sealing surface with the supply connection. The ridges 426 may also engage corresponding indents in the supply connection that may help maintain the position of the inlet connection 410 within the supply connection. Depending on the size and the shape of the ridges 426, the inlet connection 410 may be configured for multiple reuses with either the same or different supply connections. In some embodiments, the ridges may prevent removal from the supply connection without great force and/or damage to the inlet connection 410.

FIG. 4C provides a side view of the second embodiment of the claimed dispenser system installed in a bag in box assembly 480. The bag in box assembly 480 includes a spout connector 482 connected to a liquid film container 484. The spout connector 482 provides the mating surface for the inlet connection 410 of the dispenser system 400. In the fully installed condition, the flange 424 of the inlet connection 410 abuts against the front surface 486 of the spout connector 482.

FIGS. 5A and 5B provide a perspective view and a side view of a third embodiment of the claimed dispenser system. As with the first embodiment, the dispenser system assembly 500 of the third embodiment has an outlet connection 130, a valve assembly 150 with a valve body 152 and twist cap 156, as well as an alternate style inlet connection 510 as compared to the first embodiment. The inlet connection 510 is configured to mate with an alternate supply connection of a liquid source. In some embodiments, this liquid source supply connection may be a hose similar or identical to the hose connection of the dispensing system to which the outlet connection 130 affixes. The inlet connection 510 of the third embodiment has a hose barb 512 at the end similar to that of the hose barb 142 of the outlet connection 130. In some embodiments, the outer diameter of the inlet connection 510 may be identical to the outer diameter of the outlet connection 130 to allow for a similar hose to be connected to both the inlet connection 510 and the outlet connection 130.

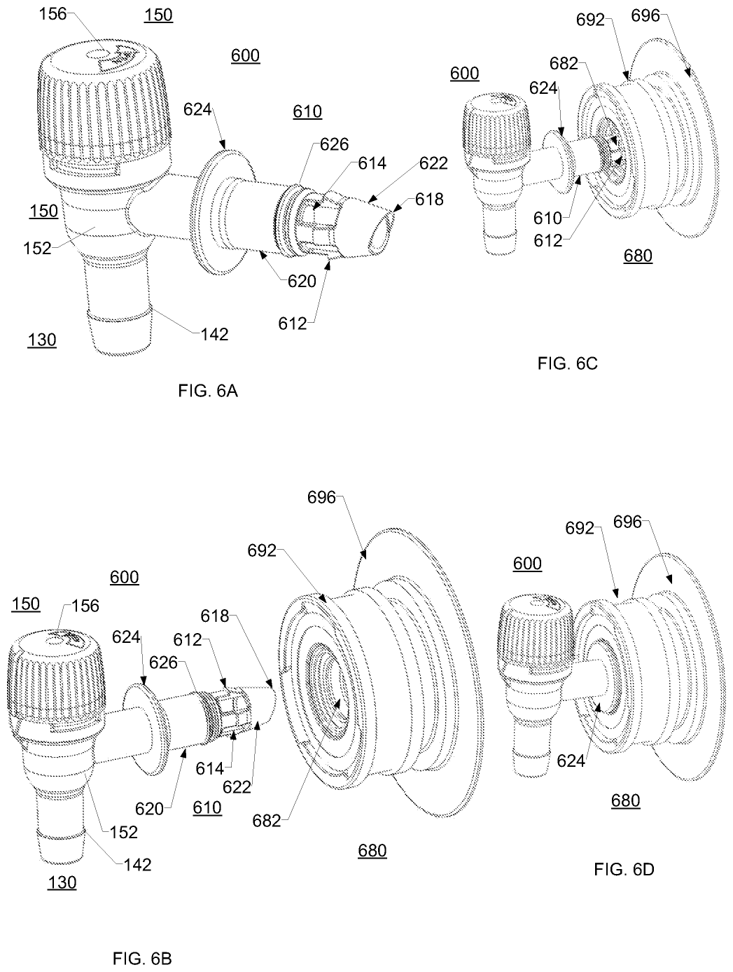

FIGS. 6A and 6B provide a first and second perspective view of a fourth embodiment of the claimed dispenser system. As with the first embodiment, the dispenser system assembly 600 of the fourth embodiment has an outlet connection 130, a valve assembly 150 with a valve body 152 and twist cap 156, as well as an alternate style inlet connection 610 as compared to the first embodiment. The inlet connection 610 has a similar taper 622 as the taper 122 of the first embodiment. However, the end of the inlet connection 610 comes to a sharp point 618 as seen in FIG. 6A. The sharp point 618 may be used to help puncture a film or membrane within the supply source to create the flow path out of the supply source and into the inlet connection 610.

The inlet connection 610 has a plurality of barbs 612. These barbs are similar to the barb of the outlet connection 142 and the barb of the inlet connection 512 of the third embodiment as they help maintain connection to a mating surface; however, rather than having a single continual barb spanning the circumference of the inlet connection, the fourth embodiment has multiple individual barbs separated radially by wall openings 614. The wall openings 614 allow for the barbs 612 to be compressed during assembly, thus allowing for the barbs 612 to extend further in an uncompressed state. Depending on the dimensions and corresponding angles, these barbs 612 may be configured to prevent the separation of the inlet connection 610 and the supply connector, potentially making the dispenser system assembly of this embodiment a single use design.

The outer surface 620 of the inlet connection 610 may also have one or more flexible sealing ridges 626 to help seal the inlet connection 610 with a supply connector 680. The inlet connection 610 also has a flange 624 to establish the fully installed depth of the inlet connection 610 into the supply connector.

FIGS. 6B, 6C, and 6D are perspective views of the dispenser assembly system 600 along with the fluid supply connector 680 in the uninstalled (FIG. 6B), partially installed (FIG. 6C), and fully installed (FIG. 6D) conditions.

FIG. 6B shows the inlet connection 610 in line with the opening 682 of the fluid supply connector 680. As shown, the fluid connector of this embodiment has an outer component 692 that mates to the spout 696 of the fluid container. A valve, film, an elastomeric sheet, or a gasket similar to the one described in reference to FIG. 3C may be used to provide a temporary seal prior to the installation of the inlet connection 610 and may be retained between the outer component 692 and the spout 696. However, the sharp point 618 at the end of the inlet connection 610 may be able to puncture the valve, film, sheet, or gasket with or without any previously existing scoring on the sealing surface.

In order to install the inlet connection 610, the operator inserts the inlet connection 610 into the fluid supply opening 682. The operator continues to insert the inlet connection 610 as seen in FIG. 6C which causes the barbs 612 to compress and allows the inlet connection's pointed end 618 to pierce the internal seal of the supply connector 680. The operator further inserts the inlet connection 610 until the flange 624 abuts against the outer surface of the outer connection 692.

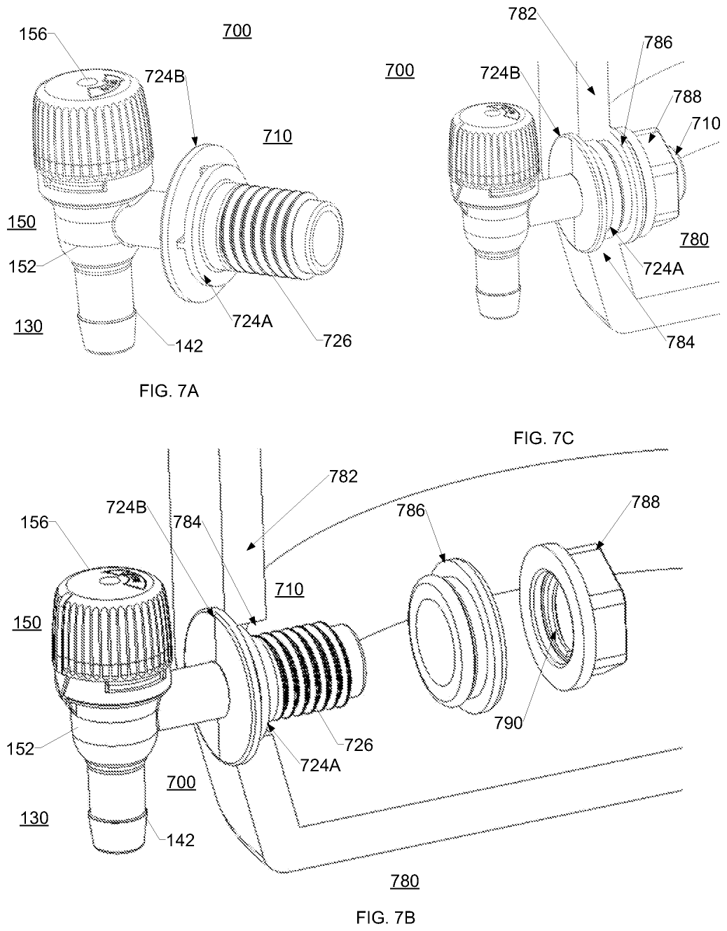

FIG. 7A provides a first perspective view of a fifth embodiment of the claimed dispenser system. As with the first embodiment, the dispenser system assembly 700 of the fifth embodiment has an outlet connection 130, a valve assembly 150 with a valve body 152, and twist cap 156, as well as an alternate style inlet connection 710 as compared to the first embodiment. In contrast to the other described embodiments of dispenser assembly system described above that use friction or barbs to maintain contact with the inlet connection and the supply connector, the inlet connection 710 of the fifth embodiment has a threaded outer surface 726 used to maintain connection with the supply connector. In some embodiments, the supply connector will have a corresponding inner surface that will mate with the external threads 726 of the inlet connection 710. In other embodiments, the inlet connection will go through an opening of the supply container. In this embodiment, a retention nut threads onto the external threads 726 of the inlet connection, drawing the dispenser inlet connection 710 in contact with the supply container.

As shown, the inlet connection 710 has a flange with a first surface 724A and a second surface 724B. In some embodiments, one of the surfaces may create a seal with the outer surface of the supply container or with a gasket between the flanged surface 724A or 724B and the outer surface of the supply container. The distance relationship between the first flanged surface 724A, the second flanged surface 724B, the thickness of the uncompressed gasket, and the dimensions of the corresponding surfaces on the supply container may also determine the amount of compression of the gasket in the fully installed condition. The outer edge of the first flanged surface 724A may also help center the inlet connection within the opening of the supply container. However, in other embodiments with only a single flanged surface, the compression of a sealing gasket may be determined by other means such as the amount of torque used to tighten the retention nut as described above.

FIGS. 7B and 7C are perspective views of the dispenser assembly system 700 along with the mating components of the fluid supply system 780 in the uninstalled (FIG. 7B), and fully installed (FIG. 7C) conditions.

A cut away view of the container 782 of the fluid supply system is shown along with the container opening 784 in which the inlet connection 710 is installed. The opening 784 in this embodiment is sized to allow the first flanged surface 724A to fit inside and let the second flanged surface 724B rest on the outer surface of the container 782. A gasket 786 creates a fluid seal between the inlet connection 710, the container 782, and/or the retention nut 788. The retention nut 788 has internal threads 790 designed to mate with the threads 726 of the inlet connection.

FIG. 7C shows the inlet connection 710 fully installed onto the container 782 of the fluid supply system 780. The retention nut 788 is fully threaded onto the threads 726 (not shown) of the inlet connection 710. The retention nut 788 compresses the gasket 786 against the inner wall of the container 782. The retention nut 788 also may compress the gasket 786 against the first flanged surface 724A.

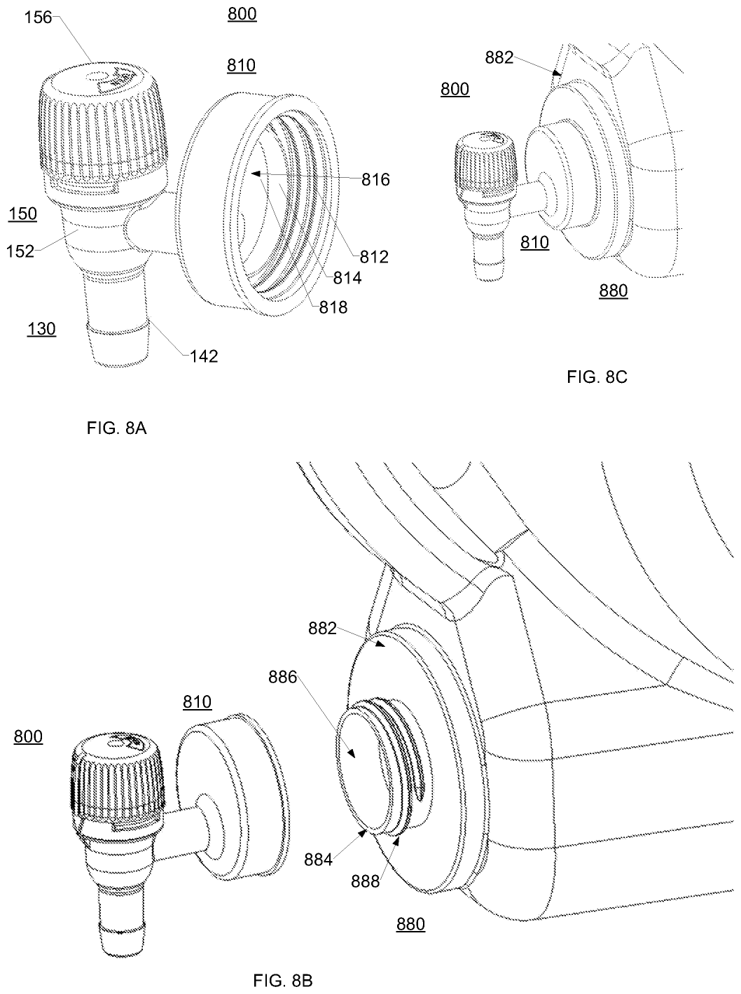

FIG. 8A provides a first view of a sixth embodiment of the claimed dispenser system. As with the first embodiment, the dispenser system assembly 800 of the sixth embodiment has an outlet connection 130, a valve assembly 150 with a valve body 152 and twist cap 156, as well as an alternate style inlet connection 810 as compared to the first embodiment. In contrast with the other embodiments described above, the inlet connection 810 is configured to attach and seal to a supply connector of the fluid source on the inner surface 818 of the inlet connection 810. As shown, the inner surface 818 of the inlet connection 810 has internal threads 812 configured to engage corresponding outer threads of a supply connector. The inlet connection 810 may have a sealing surface 814 on its inner diameter configured to mate against a corresponding outer surface of the supply connector. Alternatively, the inlet connection 810 may create a seal on an inside vertical face 816 designed to abut against the end surface of a supply connection.

FIGS. 8B and 8C are perspective views of the dispenser assembly system 800 along with the mating components of the fluid supply system 880 in the uninstalled (FIG. 8B), and fully installed (FIG. 8C) conditions. As shown in FIG. 8B, the fluid supply system 880 may be a rigid plastic container 882 with a spout 884 and an opening 886. The spout 884 may have outer threads 888 configured to mate with the internal threads 812 (not shown) of the inlet connection 810. FIG. 8C shows the inlet connection fully threaded onto the spout 884 (not shown) of the fluid supply system 880.

Although the sixth embodiment is the only example shown with a connection on the inner surface of the inlet connection, one skilled in the art would recognize similar features shown in the first through fifth embodiments on the outer surface could also be used on the inner surface such as barbs and ridges. These features may be used to either create a sealing surface and/or mechanically secure the inner surface of the inlet connection 810 to the supply connector.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, blocks and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A dispenser assembly, comprising:
an inlet connection, an outlet connection, and a valve assembly that connects the inlet connection with the outlet connection;
the inlet connection:
comprising a first cylindrical wall, a flange that extends from an outer surface of the first cylindrical wall, and a second cylindrical wall between the flange and valve assembly; and
configured to connect to a source of a liquid;
the outlet connection configured to connect to a discharge hose; and
the valve assembly:
comprising a valve body, a plunger, and a twist cap; and
configured to control the amount of flow from the inlet connection to the outlet connection based on the rotation of the twist cap;
wherein the inlet connection, the valve body, and the outlet connection are molded as a single unit.

2. The dispenser assembly of claim 1, wherein the outlet connection further comprises a barb.

3. The dispenser assembly of claim 1, wherein the flange further comprises an outer radial edge and a plurality of flange protrusions that extend from the outer radial edge.

4. The dispenser assembly of claim 1, wherein the first cylindrical wall has an outer diameter and the second cylindrical wall has an outer diameter, and the second cylindrical wall outer diameter is smaller than the first cylindrical wall outer diameter.

5. The dispenser assembly of claim 1, wherein the first cylindrical wall further comprises a pointed end.

6. The dispenser assembly of claim 1, wherein the first cylindrical wall further comprises a barb.

7. The dispenser assembly of claim 6, wherein the first cylindrical wall barb forms a continuous surface around the first cylindrical wall.

8. The dispenser assembly of claim 6, wherein the first cylindrical wall barb comprises a plurality of separate points around the first cylindrical wall.

9. The dispenser assembly of claim 8, wherein the first cylindrical wall further comprises a plurality of wall openings between the separate points.

10. A dispenser assembly, comprising:
an inlet connection, an outlet connection, and a valve assembly that connects the inlet connection with the outlet connection;
the inlet connection:
comprising a cylindrical wall and a threaded surface extends from the cylindrical wall; and
configured to connect to a source of a liquid;
the outlet connection configured to connect to a discharge hose; and
the valve assembly:
comprising a valve body, a plunger, and a twist cap; and
configured to control the amount of flow from the inlet connection to the outlet connection based on the rotation of the twist cap;
wherein the inlet connection, the valve body, and the outlet connection are molded as a single unit.

11. The dispenser assembly of claim 10, wherein the outlet connection further comprises a barb.

12. The dispenser assembly of claim 10, wherein the threaded surface extends from the inner surface of the cylindrical wall.

13. The dispenser assembly of claim 10, wherein the threaded surface extends from the outer surface of the cylindrical wall.

14. The dispenser assembly of claim 13, wherein the dispenser assembly further comprises a gasket and a retention nut, wherein the gasket and the retention nut fit over the outer threaded surface.

15. A dispenser assembly, comprising:
an inlet connection, an outlet connection, and a valve assembly that connects the inlet connection with the outlet connection;
the inlet connection:
comprising a cylindrical wall and a barb extending from the cylindrical wall; and
configured to connect to a source of a liquid;
the outlet connection configured to connect to a discharge hose; and
the valve assembly:
comprising a valve body, a plunger, and a twist cap; and
configured to control the amount of flow from the inlet connection to the outlet connection based on the rotation of the twist cap;
wherein the inlet connection, the valve body, and the outlet connection are molded as a single unit.

16. The dispenser assembly of claim 15, wherein the outlet connection further comprises a barb.

17. The dispenser assembly of claim 16, wherein the inlet connection has an outer diameter and the outlet connection has an outer diameter that is the same as the inlet connection outer diameter.

18. The dispenser assembly of claim 15, wherein the inlet connection further comprises a tapered end.
